(19) United States
(12) Patent Application Publication
(10) Pub. No.: US 2002/0090874 A1
(43) Pub. Date: Jul. 11, 2002

(54) Unitized fastenerless composite structure

(76) Inventors: Elbert L. McKague JR., Fort Worth, TX (US); Marvin D. Black, Fort Worth, TX (US)

Correspondence Address: Darryl M. Tyus, BRACEWELL & PATTERSON LLP, P O Box 61389, Houston, TX, 77208-1389, US

(21) Appl. No.: 09/755,221

(22) Filed: Jan. 5, 2001

Related U.S. Application Data
(60) Provisional application No. 60/231,245, filed on Sep. 8, 2000.

(51) Int. Cl. B32B 5/06; B32B 5/26; B32B 27/04; B32B 27/12

(52) U.S. Cl. 442/275; 442/278; 428/300.7; 442/281

(57) ABSTRACT

Plies of continuous fiber material are oriented and cut to the intended shape of a structural component, such as the vertical tail of an aircraft. Two skins or laminates are created by laying the cut-to-shape plies into a matched mold, with over-woven or over-braided mandrels or similar tooling details placed between the skins. The mold is closed and a thermosetting resin is injected into the mold to fully impregnate any fibers that were unimpregnated at the time of mold closure and to fully fill all void areas inside the mold. The mold is held closed with pressure, such as by a press, and heated to cure the resin while the resin in the mold is subjected to a hydrostatic pressure sufficient to constrain growth of voids. The contiguous faces of the impregnated braid or weave covering the mandrels are united by the resin, forming vertical or angular laminate between the inner faces of the skins. The resin similarly unites the portions of the braids or weaves that are contiguous with the inner surfaces of the skins, bonding the braids or weaves to the skins to create a unitized structure. The resulting structure is capable of functioning without addition of mechanical fasteners that are required in conventional structures to join skins to understructure.

This application claims the benefit of a copending U.S. provisional application, Serial No. 60/231,245, filed on Sep. 8, 2000, by Applicant.

### BACKGROUND OF THE INVENTION

1. Technical Field:

The present invention relates in general to an improved structural design, and in particular to an improved structure composed of skins and understructure. Still more particularly, the present invention relates to a unitized structure concurrently fabricated from composite materials in such a way that mechanical fasteners are not required.

2. Description of the Prior Art:

In the prior art, structural components such as aircraft empennage members are fabricated by individually making skins and understructure elements and then assembling them into the final component using mechanical fasteners. This requires drilling and countersinking holes, reaming and cleaning holes, buying and installing mechanical fasteners, and in some cases applying a fairing material to the fastener heads. Together, these processes cause high costs for building such components.

In some more advanced methods, one composite skin is fabricated with composite understructure co-cured to it and then a separately fabricated skin is mechanically fastened to finish the assembly. This approach typically has required hand-lay of prepreg materials to create the understructure details, and usually has required relatively complex tooling to locate and provide pressure to all of the material during cure. This hand-lay and use of the mechanical fasteners to attach the separately processed skin have driven costs to levels higher than desired.

### SUMMARY OF THE INVENTION

A laminate or skin is formed from composite material. This skin may be formed using prepreg material, unimpregnated fibrous material, or combinations of these two. The material for this skin is laid onto one half of a matched die mold or onto an appropriately shaped tool from which it is transferred to the matched die tool half. A series of tooling mandrels, each wrapped with unimpregnated reinforcing fibers, are placed onto the skins so that they are precisely located with respect to prescribed datum dimensions. A second skin is formed from the same materials as the first skin and in the same manner, being either laid directly over the wrapped mandrels and lower skin or transferred to it. Then the mating half of the matched die is placed over the resulting assembly, and then sealed to the lower die half. This tooling assembly then is placed into an appropriate restraint device, such as a press or clamping fixture, and resin is injected into the mold to completely fill all void spaces between fibers within the mold. The resin is heated to cure, and then the mold is opened, mandrels are removed, and the unitized composite component is removed.

The cured component conforms to the exact geometric shape required for the intended structure, such as an aircraft vertical tail. Both inside and outside dimensions of the component are accurately rendered by cure of the injected resin inside the tool that has the required shape. Both skins are integrally connected to the understructure material between them as a result of a common matrix of cured resin.

Accordingly, it is an object of the present invention to provide a unitized structural component.

It is an additional object of the present invention to provide an improved structural component that is unitized without mechanical fasteners or secondary adhesive bonding.

Another object of the present invention is to provide a unitized, fastenerless structural composite assembly that conforms to a required geometric shape with closely held dimensional accuracy.

Still another object of the present invention is to provide a low cost method of fabricating a composite assembly.

The foregoing and other objects and advantages of the present invention will be apparent to those skilled in the art, in view of the following detailed description of the preferred embodiment of the present invention, taken in conjunction with the appended claims and the accompanying drawings.

### BRIEF DESCRIPTION OF THE DRAWINGS

So that the manner in which the features, advantages and objects of the invention, as well as others which will become apparent, are attained and can be understood in more detail, more particular description of the invention briefly summarized above may be had by reference to the embodiment thereof which is illustrated in the appended drawings, which drawings form a part of this specification. It is to be noted, however, that the drawings illustrate only a preferred embodiment of the invention and is therefore not to be considered limiting of its scope as the invention may admit to other equally effective embodiments.

FIG. 1 is a schematic, isometric drawing of a laminate or skin representing one side of an intended structural component.

FIG. 2 is a view showing a laminate or skin resting on one half of a matched die or mold.

FIG. 3 is an illustration of a series of mandrels that define the internal substructure configuration of an intended structural assembly.

FIG. 4 is an illustration showing unimpregnated graphite reinforcing fibers braided to form a tightly conforming sock or sleeve over a mandrel of FIG. 3.

FIG. 5 is an isometric illustration showing a series of over-braided mandrels placed on top of a laminate or skin that rests on one half of a matched die or mold.

FIG. 6 is an isometric illustration showing a second laminate or skin placed on top of the over-braided mandrels of FIG. 5.

FIG. 7 is a section view of the assembled tool containing the upper and lower skins and the over-braided mandrels of FIG. 6.

### DETAILED DESCRIPTION OF THE PREFERRED EMBODIMENT

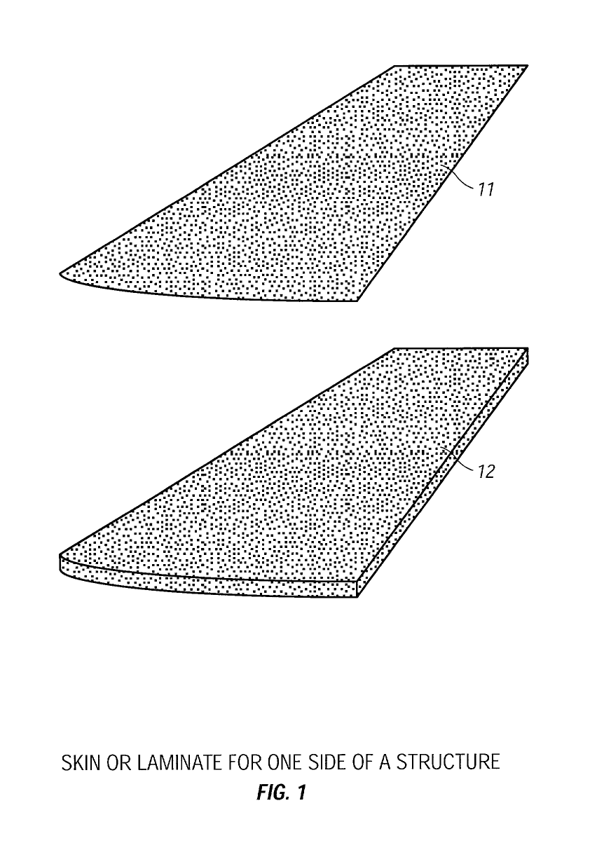

Referring to FIG. 1, a skin or laminate 12 is formed by stacking layers or plies 11 of fibrous reinforcing material onto a suitable tool or surface. Long, continuous fibers in each ply are oriented in specific directions to provide subsequent strength and stiffness in directions subject to loading during use. In the preferred embodiment, the layers or plies 11 are not impregnated with resin. However, acceptable results also can be obtained when the layers or plies 11 are partially or fully impregnated with resin, or when some of the layers are unimpregnated and some are either partially or fully impregnated with resin. Acceptability of both the latter combinatorial case and of the preferred embodiment has been demonstrated. To more fully explain, the layers or plies 11, whether impregnated or unimpregnated, may be provided in several different material forms. In one form, they may be composed of unidirectional “fabrics”, i.e., layers of collimated fibers held together by a sparse number of transverse thread or fibers. In another form, the layers may be of a woven fabric such as 5-harness satin weave fabric. In both of these forms, the layers or plies 11 may be either unimpregnated, fully impregnated, or partially impregnated with resin. In still another form, the layers or plies 11 consist of collimated or unidirectional fibers that are partially or fully impregnated with resin.

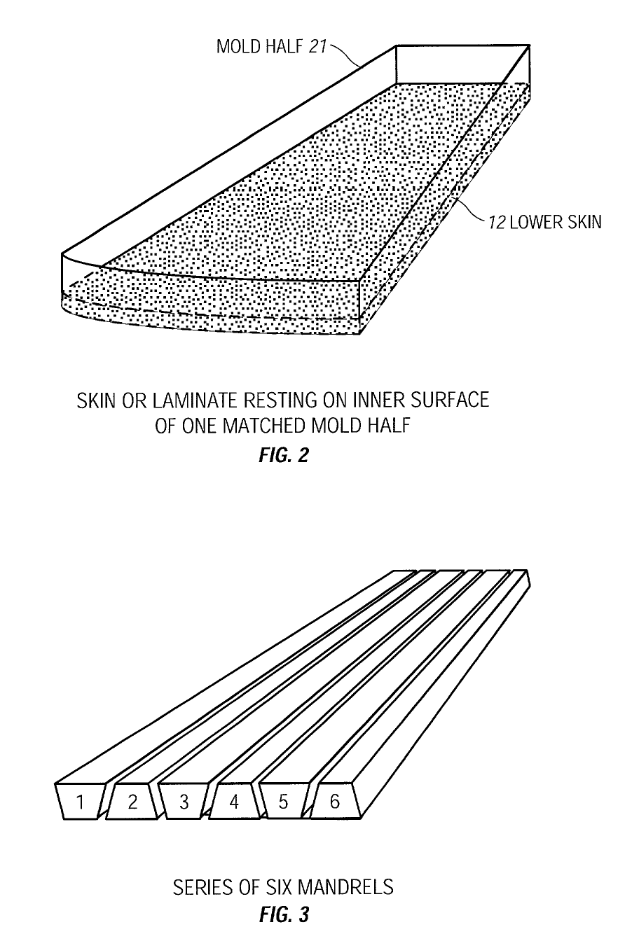

As shown in FIG. 2, the skin or laminate 12 of FIG. 1 is created by laying layers or plies 11 onto the surface of a tool 21 that represents half of a matched die. Alternatively the skin or laminate 21 can be created and then transferred to the tool half 21.

Referring now to FIG. 3, a series of mandrels are created, typically by NC Machining, each with a general configuration determined according to structural requirements for the internal structure of a unified structure such as a vertical tail for an aircraft.

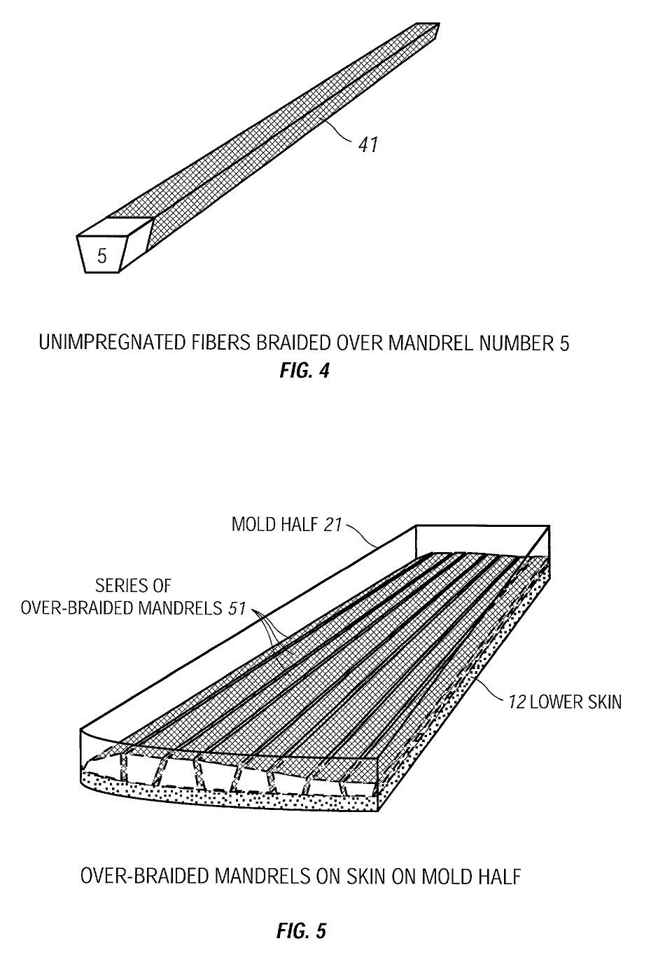

As illustrated by FIG. 4, unimpregnated tows or bundles of continuous fibers are braided over each mandrel 5 to form a “sock” or “sleeve” 41. Together, these “socks” or “sleeves” will form the internal structure of the unitized composite component.

FIG. 5 is an isometric illustration showing a series of mandrels 51 placed on top of a skin or laminate 12 that rests on one half of the matched die tool 21. The braided “sock” or “sleeve” 41 on the side of a given mandrel mates against the side of the “sock” or “sleeve” covering the adjacent mandrel. These “socks” or “sleeves” will be filled by injecting with resin, pressed against each other, and made rigid by curing resin. Together these mating faces will form a structural web of members that will connect the first skin or laminate 12 to a second skin or laminate that will be applied prior to such resin injection and cure.

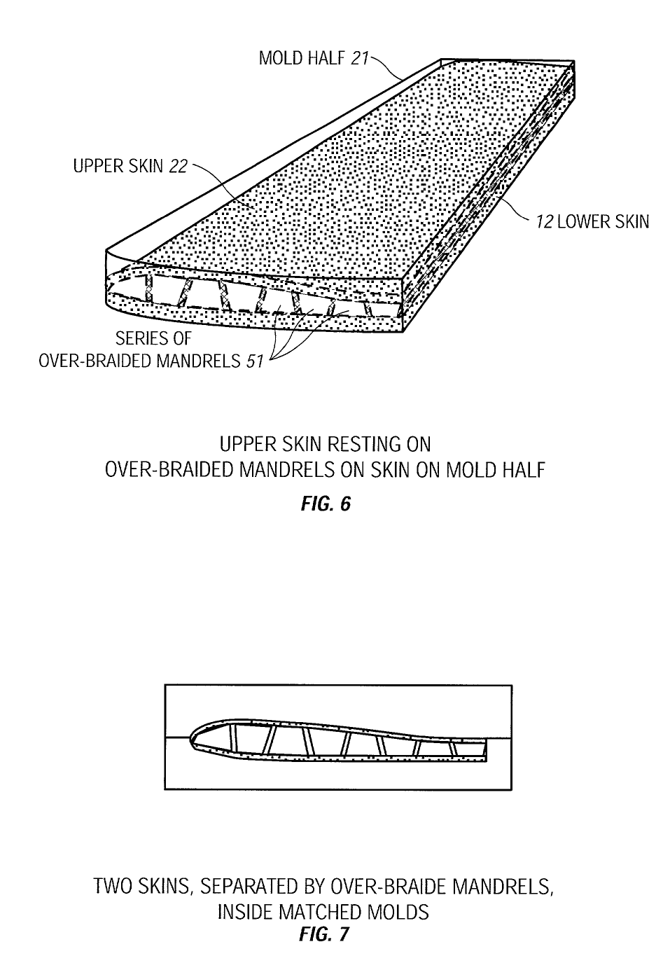

FIG. 6 is an isometric illustration showing the second skin or laminate 22 resting on the over-braided mandrels of FIG. 5. Again, this skin can be formed by stacking suitable layers or plies 11 directly onto the socked mandrels or in a separate location and then transferred to and placed onto the socked mandrels.

At this point, as shown in FIG. 7, the other half of the matched die or mold is placed on top of the assembly. Then the assembled component and matched die are placed into a suitable hydraulic press or equivalent restraining device. The mold may be sealed to sufficiently hold a vacuum either before or after being placed in a hydraulic press or restraining device.

A suitable thermosetting resin is selected that has low viscosity at some temperature allowing an adequately long injection life. This resin is injected into the mold, creating an internal pressure that is resisted by the press or restraining device. This resin is injected into the mold through injection ports arranged at various locations around the matched mold. These ports are located in such a way that the flowing resin completely fills the mold, wetting any unimpregnated or partially impregnated layers or plies in the skins and all of the unimpregnated braided “socks” or “sleeves” surrounding each of the internal mandrels. After filling the dry or void areas of the mold with resin, the mold is heated to and held at a temperature sufficient to cause curing of the injected resin. After cure, the mold is removed from the press or restraining fixture, the top half of the mold is removed, any side plates that were installed are removed, and then the completed component is removed from the mold. With appropriate handling procedures and protective devices, removal can be accomplished hot, before the mold cools appreciably.

The invention has several advantages as it provides a completely assembled, low-cost, weight efficient structure consisting of two skins or laminates structurally connected by the co-cured, braided “socks” or “sleeves”. Just as the mating braids on the sides of adjacent mandrels were pressed together, infused with resin, and cured into one member, so too are the portions of the “socks” or “sleeves” at the top and bottom of each mandrel joined to the mating surfaces of the skins or laminates. Being commonly infused with the same resin and cured together, the braided “socks” or “sleeves” are bonded to the skins with the same efficiency as each layer or ply of the skin or laminate is bonded to the layer or ply above and below it.

While the invention has been shown or described in only some of its forms, it should be apparent to those skilled in the art that it is not so limited, but is susceptible to various changes without departing from the scope of the invention. For example, a series of appropriately shaped “C” channels made of low resin content fabric could be used instead of the braided “socks” or “sleeves”. In another variation, all of the layers or plies of each skin could be composed of narrow strips of fully impregnated unidirectional fibers that are “fiber placed”, i.e., laid into the laminate using an NC machine. If all of the layers or plies are fully impregnated with resin, then the resin in the skins could be different than the one used to inject and impregnate the braided “socks” or “sleeves”—provided that the two resins are compatible with curing together and yielding a strong interface layer. In another variant, the skins or laminates could be partially or fully cured so that the resin injected into the internal structural members creates an interface bond between the skins and understructure. In a case like this, the cured skins might be placed into the mold with a layer of film adhesive applied to the faces to toughen the bonds with the understructure.

What is claimed is:

1. A structural assembly or component comprising:
a pair of outer skins or laminates, each formed from layers or plies of continuous fiber reinforced composite;
an inner structure located between the outer laminates such that the outer laminates are coupled together;
a series of understructure details consisting of unimpregnated or partially impregnated woven material; and
a series of understructure details which are tapered and each of which is supported by a suitable mandrel during handling and prior to cure of a thermosetting resin that is infused.

2. The structural assembly or component of claim 1 wherein the understructure is formed from braided fibers.

3. The structural assembly or component of claim 1 wherein the understructure is formed from woven fibers.

4. The structural assembly or component of claim 1 wherein the understructure is formed by braiding “socks” or “sleeves” over mandrels that define the internal geometry of the finished substructure.

5. The structural assembly or component of claim 1 wherein the outer skins or laminates are composed of layers of unimpregnated continuous fiber materials.

6. The structural assembly or component of claim 1 wherein the outer skins or laminates are composed of layers of unimpregnated continuous fiber materials intermixed with layers of fully impregnated continuous fiber materials.

7. The structural assembly or component of claim 1 wherein the outer skins or laminates are composed of some layers of unimpregnated continuous fiber materials intermixed with some layers of fully impregnated continuous fiber materials and some layers of partially impregnated continuous fiber materials.

8. The structural assembly or component of claim 1 wherein the outer skins or laminates are composed completely of layers of fully impregnated continuous fiber materials.

9. The structural assembly or component of claim 8 wherein a layer of uncured film adhesive is placed on the inner surface or each skin to toughen the cured interface between the skins and the understructure.

10. A structural assembly or component comprising:
external skins or laminates joined to a series of contiguous structural channels or tubes or beams; and
unitized by composite structural details joined by cured thermosetting resin that provides mechanical integrity without use of mechanical fasteners.

11. The structural assembly or component of claim 10 wherein the resin permeates the structure leaving few or no voids.

12. The structural assembly or component of claim 10 wherein the resin is injected or transferred into the structure.

13. The structural assembly or component of claim 10 wherein the inner and outer mold lines of each skin are accurately defined and held to close dimensional tolerances defined by a matched mold.

14. The structural assembly or component of claim 10 wherein the internal structural details are dimensionally accurate and defined by dimensions and geometry of mandrels or similar tooling details.

15. A method for fabricating a structure or component comprising the steps of:
(a) creating skins or laminates by laying layers of plies of continuous fiber materials containing a low resin content of less than 20% by weight;
(b) braiding or weaving unimpregnated fibers to conform to the external shape of mandrels;
(c) placing one skin onto the inner face of one half of a matched mold;
(d) placing the over-braided or over-woven mandrels onto the skin so that they are contiguous with one another;
(e) placing the other skin onto the top of the over-braided or over-woven mandrels;
(f) placing the other half of the matched mold over the skin of step (e) so that the inner face of the mold half is against the skin;
(g) placing the resulting tooling/component assembly into a hydraulic press and applying a compacting force that results in mold closure;
(h) sealing the mold and drawing a vacuum inside the closed mold;
(i) heating the mold, injecting resin into the mold to completely fill void areas, and pressurizing the resin to a level sufficient to suppress formation of voids that could be caused by moisture, solvents, or volatile reaction products; and
(j) heating the mold to a temperature for a period sufficient to cause cure of the thermosetting resin, removing the top half of the mold, withdrawing the internal mandrels or similar tooling details, and removing the part from the mold.

16. The method of claim 15 wherein the skins are formed by laying fully impregnated strips of continuous fiber material using automated machine methods.

17. The method of claim 15 wherein the skins are formed by laying fully impregnated layers of continuous fiber material.

18. The method of claim 15 wherein the skins or laminates are formed by intermixing layers of low resin content layers and unimpregnated layers.

19. The method of claim 15 wherein the skins are formed by intermixing layers of partially impregnated and fully impregnated continuous fiber materials.

20. The method of claim 15 wherein the skins are formed by intermixing layers of partially impregnated and unimpregnated continuous fiber materials.

21. The method of claim 15 wherein the skins are formed by intermixing layers of fully impregnated and unimpregnated continuous fiber materials.

22. The method of claim 15 wherein the skins are formed by intermixing partially, fully, and unimpregnated layers of continuous fiber materials.

23. The method of claim 15 wherein the skins are formed from material selected from the group consisting unimpregnated continuous fibers, partially unimpregnated continuous fibers, fully unimpregnated continuous fibers, and unidirectional fabric and woven fabric.

24. The methods of claim 15-23 wherein the layers formed the skins are not debulked prior to closing the mold in the press.

25. The methods of claim 15-23 wherein the layers forming the skins are debulked prior to closing the mold in the press.
